(19) United States
(12) Patent Application Publication
(10) Pub. No.: US 2025/0151641 A1
(43) Pub. Date: May 15, 2025

(54) METHOD FOR FORMING A PLANT NUTRIENT SOLUTION, AND DOSING CONTAINER THEREFOR

(71) Applicant: Hauert HBG Dünger AG, Grossaffoltern (CH)

(72) Inventors: Philipp HAUERT, Bern (CH); Christoph Peter BÜSCHER, Wiehl (DE)

(73) Assignee: Hauert HBG Dünger AG, Grossaffoltern (CH)

(21) Appl. No.: 18/939,158

(22) Filed: Nov. 6, 2024

(30) Foreign Application Priority Data
Nov. 9, 2023 (EP) 23 208 752.8

(51) Int. Cl. A01C 23/00; A01C 21/00; A01C 23/04; B65D 81/32

(52) U.S. Cl. CPC A01C 23/007; A01C 21/00; A01C 23/042; B65D 81/3222

(57) ABSTRACT

The invention relates to a method and dosing container for forming a plant nutrient solution, particularly for plants in house and garden, wherein powder fertilizer components, particularly powder nutrient salts, are stored in a container, and the powder fertilizer components are added to a carrier liquid, wherein the plant nutrient solution is formed for fertilizing, characterized in that a closed dosing container having a discharge opening at a top end of the dosing container is used as the container, wherein a receiving bowl having a receiving opening directed towards the discharge opening of the dosing container and a dosing pipe extending from the discharge opening up into the region of the receiving bowl are arranged in the dosing container, and, in that, in order to dispense a metered quantity of powder fertilizer components, the receiving bowl is filled with a quantity of powder fertilizer components, in particular by turning around the dosing container from the top side to the bottom side and back, and once the receiving bowl has been filled, the dosing container is turned from the top side to the bottom side, wherein a metered quantity of powder fertilizer components is discharged from the receiving bowl via the dosing pipe in a targeted manner through the downwardly directed discharge opening, in particular directly into the carrier liquid.

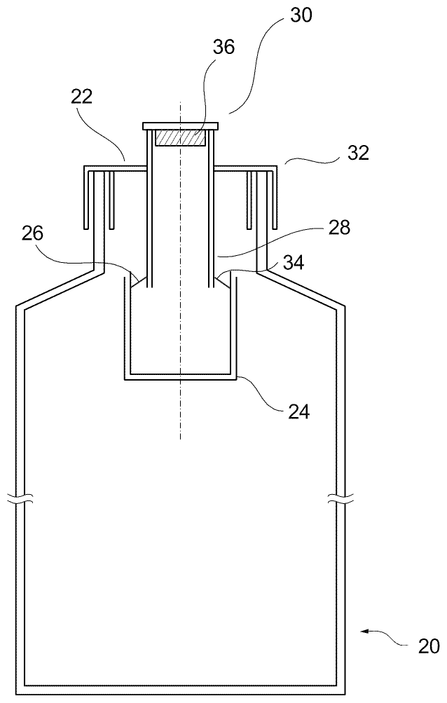

The invention relates to a method for forming a plant nutrient solution, particularly for plants in house and garden, wherein powder fertilizer components, particularly powder nutrient salts, are stored in a container. The powder fertilizer components are added to a carrier liquid, wherein the plant nutrient solution is formed for fertilizing, according to the preamble of claim 1.

The invention further relates to a dosing container for receiving powder fertilizer components, particularly powder nutrient salts, and for the targeted discharge of a metered quantity thereof, in particular to form a plant nutrient solution, particularly for plants in house and garden, according to the preamble of claim 5.

Plant nutrient solutions ensure strong growth and intense coloration in green plants. In addition, resistance ability against diseases and pests is increased. It is known that such plant nutrient solutions can be formed by adding a liquid fertilizer or fertilizer salts to irrigation water.

Generic methods for forming plant nutrient solutions have been known for a long time. By using such methods, plant nutrient solutions from readily soluble fertilizer salts can easily be produced, for example, for improved plant growth in house and garden plants. To produce the plant nutrient solution, a specified quantity of a powder fertilizer is typically dissolved in water. The correct dose of fertilizer is crucial in this process step. This is often taken place from a can-like container with a relatively large access opening by using a measuring spoon. For applications in the home and hobby sector, using a measuring spoon to measure out the dose is prone to error. Over—or underfeeding can result in damage the plants.

In addition, a large access opening in a can-like container always means a large area of contact between the fertilizer salts and the surrounding air and the atmospheric moisture containing therein. This can lead to undesirable crusting and agglomerating of the readily soluble salts. Over a longer time, this has an adverse effect on the dosability and rapid solubility of the fertilizer product. In extreme cases, the fertilizer product becomes unusable for the user.

The advantage over liquid fertilizers is that said salts are more compact and easier to store and hence simpler to transport. The object of the invention is based on to specify a method and a dosing container with which a handling of powder fertilizer components to form a plant nutrient solution for fertilizing is simplified, and the longevity of the fertilizer product is increased at the same time.

The object is achieved according to the invention on the one hand by a method for forming a plant nutrient solution having the features of claim 1 and on the other hand by a dosing container having the features of claim 5. Preferred embodiments of the invention are indicated in the dependent claims.

The method according to the invention for forming a plant nutrient solution is characterized in that a closed dosing container having a discharge opening at a top end of the dosing container is used as the container, wherein a receiving bowl having a receiving opening being directed towards the discharge opening of the dosing container and a dosing pipe extending from the discharge opening up into the region of the receiving bowl, are arranged in the dosing container, and, in that, in order to dispense a metered quantity of powder fertilizer components, the receiving bowl is filled with a quantity of powder fertilizer components, in particular by turning around the dosing container from the top side to a bottom side and back, and, once the receiving bowl has been filled, the dosing container is turned around from the top side to the bottom side, wherein a metered quantity of powder fertilizer components is discharged from the receiving bowl via the dosing pipe in a targeted manner through the downwardly directed discharge opening, in particular directly into the carrier liquid.

An underlying basic concept of the invention consists in measuring out a dose of powder fertilizer components to form a plant nutrient solution by means of executing simple rotary movements of a specially configured dosing container. The dosing container, which, in particular can be grabbed by person as user in one hand, has an inner receiving bowl with a receiving opening, which is filled with a specified metered quantity of powder fertilizer components by means of a first rotary movement. A second rotary movement causes this said quantity of powder fertilizer component to enter a dosing pipe, and from there it is discharged through a downwardly directed discharge opening, in particular directly into irrigation water. In this way, a simple and efficient dosing of fertilizer components to form a plant nutrient solution for fertilizing is ensured in a short instant, so to speak. In particular, the fertilizing of plants in house and garden is simplified considerably by the method described here. A metered quantity that is discharged by each dispensing rotation can be configured for a quantity of carrier liquid (irrigation water) of 0.5 l or 1 l, for example. Other specifications are readily achievable by adjusting, in particular the receiving bowl and/or the dosing pipe.

The inventive configuration of the dosing container significantly limits an ingress of ambient air into the container interior. The fertilizer components are thus better protected from the impacts of atmospheric moisture. They remain free-flowing and readily soluble for longer. This increases the utility purpose and longevity of the fertilizer product. In addition, the rotary movement involved with using ensures frequent mixing of the fertilizer components, which counteracts undesirable crusting and solidifications.

The receiving bowl can in principle be filled with any quantity of fertilizer, wherein the fertilizer can contain various fertilizer salts, in particular NPK fertilizers, nitrogen variations, such as nitrate nitrogen, total nitrogen, phosphate, water-soluble potassium oxide, water-soluble boron, water-soluble copper, water-soluble iron, water-soluble manganese and water-soluble zinc.

In a preferred embodiment of the invention resides in that the receiving bowl is filled with a quantity of powder fertilizer components such that a lower end of the dosing pipe dips into the quantity of powder fertilizer components and a free passage of air from the dosing pipe in the dosing container is blocked. An ingress of atmospheric moisture to the plant nutrients in the container is largely prevented in this way. An undesired introduction of foreign bodies is also counteracted.

In a further advantageous configuration of the invention resides in that the powder fertilizer components are screened during discharging. A screen, for example, which is arranged in the dosing pipe or at the outer ends of the dosing pipe, can be provided for this purpose. A number of advantages can be achieved in this way: firstly, the introduction of foreign bodies of a certain size from the outer region into the dosing pipe is prevented, and secondly, a more uniform discharge of the fertilizer components from the dosing pipe can be achieved. It is also possible for specific portions of the powder fertilizer components to be held back.

In a preferred embodiment, it is provided that an agent having hydrophilic properties is arranged in the dosing container, particularly in an upper region of the dosing container, separated from the fertilizer components. Moisture is bound in the dosing container in this way. Silicate or a silicate composite, for example, can be used for this purpose. The arrangement can be taken place at any suitable point in the dosing container, including at the dosing pipe or in the receiving bowl, for example. The agent can preferably be attached to at least one side wall of the dosing container, as a silicate gel or silicate container, for example, and can act as a hydrophilic capture device. A wetting and hence crusting of the powder fertilizer components is counteracted in this way.

The invention further comprises a dosing container for receiving powder fertilizer components, which is characterized in that the container is designed as a closed dosing container with a discharge opening at a top end of the dosing container, in that a receiving bowl for receiving a portion of fertilizer components and having a receiving opening is designed in the dosing container, which receiving opening is directed towards the discharge opening of the dosing container, and, in that, moreover, a dosing pipe is arranged in the dosing container, extending from the discharge opening into the region of the receiving bowl, and in that the receiving bowl and the dosing pipe are arranged in relation to one another in such a way that, by turning the dosing container from the top side to a bottom side and back, the receiving bowl can be filled with a quantity of powder fertilizer components, and in that by turning around the dosing container from the top side to the bottom side, a metered quantity of powder fertilizer components can be discharged from the receiving bowl in a targeted manner via the dosing pipe through the downwardly directed discharge opening.

In particular, the method according to the invention as described above can be carried out with the dosing container. The advantages described above are achieved with the dosing container.

It can be advantageous here for the receiving bowl to be cylindrical and to be designed in a shape that narrows towards the bottom end, since the powder fertilizer components can thus enter the dosing pipe in a more targeted manner. By using this device, the dosing of fertilizer components when forming a plant nutrient solution for fertilizing can be made simpler and more precise. An advantage of this is that consumers can measure out the fertilizer components by simple tipping movements and can add them to a specified quantity of water, for example, or directly onto the plants.

It is particularly preferable in this case for a cover lid to be arranged on the dosing pipe to close off the dosing pipe. An undesired release of the powder fertilizer components can be prevented in this way. In addition, neither atmospheric moisture nor undesirable foreign bodies can get into the dosing container. It is also advantageous here for the cover lid to be configured to maintain an overpressure.

The cover lid can be configured in various ways. In this regard, an embodiment of the invention resides in that the cover lid is mounted so as to be pivotable between a closed position and a discharge position, wherein the cover lid is in its closed position when the discharge opening is directed upwards, and the cover lid is in the discharge position when the discharge opening is directed downwards. This simplifies the handling of the dosing container and ensures that the receiving bowl is completely emptied through the dosing pipe.

Alternatively or in addition to that, according to a continuing configuration of the invention, it can be advantageous for the dosing pipe to extend into a central region of the receiving bowl, wherein an annular through-gap for filling the receiving bowl is formed between the central dosing pipe and a surrounding wall of the receiving bowl. This ensures that when the dosing container is turned from the topside to the bottom side and back, the powder fertilizer components attain the receiving bowl. In this case, at least one cross-strut can pass through the annular through-gap.

Alternatively, the dosing pipe can also extend into a side region of the receiving bowl. It has proved particularly advantageous in this case for the dosing pipe to widen out conically in the lower region. This ensures that the complete metered quantity of powder fertilizer components attains the dosing pipe when the dosing container is turned around. In addition, the dosing pipe can be connected to the bottom of the receiving bowl at one or more points. Depending on the position of the dosing pipe, the receiving bowl can either be located suspended in air, centrally below the discharge opening or can be installed fixed to a side wall of the dosing container.

A further advantageous configuration of the invention resides in that the dosing pipe is designed on a container lid which is attached, particularly screwed, to the discharge opening of the dosing container. The dosing container can thus be refilled in a straightforward manner and a conventional container can be used. The container lid can be configured as a dosing head.

In principle, the receiving bowl and the dosing pipe can be manufactured separately and then joined together. In a preferred embodiment, it is provided that the receiving bowl and the container lid with the dosing pipe are designed together as a dosing unit, in particular in one piece. It is particularly advantageous in this case for the cylindrical dosing pipe to project vertically upwards from the plane of the container lid. This makes it easier to introduce the metered quantity emerging from the dosing pipe into another container, for further processing for example. Here, the dosing pipe can taper to a point at the top end. An advantage of the dosing unit resides in that the receiving bowl, the container lid and the dosing pipe can be removed from the dosing container as a belonging together unit, for inspection purposes, for example.

The receiving bowl is particularly preferably joined to the dosing pipe by at least one stud link. The at least one stud link can be obliquely formed, for example, and connect the inner pipe to the receiving bowl. Alternatively or in addition thereto, the at least one stud link can be designed in a horizontal, vertical or inclined position. It is also conceivable for the stud link to be configured as a perforated sealing ring between the inner pipe and an inner wall of the receiving bowl. The receiving bowl can advantageously be mounted suspended in air below the receiving opening by the at least one stud link.

A further advantageous configuration of the invention resides in that the dosing pipe has a screen, through which the fertilizer components pass when the filled receiving bowl is turned and through which only particles of the fertilizer component up to a predefined size can pass. Alternatively or in addition thereto, a filter device can be provided in said dosing pipe, by means of which foreign bodies are advantageously kept out. Said screen can be circular in shape and can have square mesh openings to filter particles of a certain size. A significant advantage of this configuration is that the powder fertilizer components flow evenly out of the dosing pipe when the dosing container is turned around and that, in addition, unsuitable particles and foreign bodies are filtered because of their size.

According to a continuing configuration of the invention, it can be advantageous for an agent having hydrophilic properties, particularly a silicate, to be arranged in the dosing container. There are provided various possibilities in this case. For example, a silicate gel can be distributed evenly over the inner surfaces of the dosing container. Alternatively, silicate containers can also be provided, which are arranged on the inner surfaces of the dosing container. The hydrophilic properties can prevent the powder fertilizer components from imbruing. This increases the longevity of the product, for example.

The dosing container can in principle be shaped in various ways. In a particularly advantageous embodiment resides in that the dosing container narrows towards the top end, in particular in the region of the discharge opening. This makes handling, for example, and, in particular the installation of the dosing unit, easier. The dosing container can have a handle for easier handling by a person. The filling volume is preferably up to 2 l.

It is particularly preferable according to the invention for the container lid to be connected to the dosing container by means of a push-in connection or a screw connection. The push-in connection can be implemented by means of one or more projecting stud links. Such a connection of the container lid to the dosing container allows for easy filling the dosing container in the manufacturing process. In addition, the fill level of the receiving bowl can be checked in this way.

The invention is explained in more detail below by reference to a preferred exemplary embodiment, which is illustrated schematically in the drawing.

The FIGURE shows a cross-section of the container used in the method according to the invention to form a plant solution.

The FIGURE shows a schematic cross-sectional view of a dosing container 20, wherein the sectional plane cuts centrally and vertically through the two container walls as well as a dosing unit. The basic shape of the container is a cylinder, which narrows towards the top. The basic shape can be designed in any shape, particularly also a rectangular shape. With the shape that is shown here, the powder fertilizer components contained in the dosing container 20 can collect in a concentrated manner in a region on a closed discharge opening 22 when the container is rotationally moved. When it is rotationally moved again, a specified dose of powder fertilizer components attains a receiving bowl 24 of the dosing unit in a targeted manner. By rotationally moving the container yet again, the powder fertilizer components are dispensed from the receiving bowl 24 through a dosing pipe 28 into the surrounding area, in particular into a carrier liquid to form a plant nutrient solution.

The receiving bowl 24 and the dosing container 20 can in principle have any shape that proves advantageous in terms of handling, storage or filling, especially filling the receiving bowl 24. The dosing container 20 can preferably be filled via the discharge opening 22, but also in principle via a separate opening in the bottom region at the bottom end. The dosing container 20 can be formed in particular from a transparent, i.e. light-permeable, material. A volume scale can be provided in the region of the main body of the dosing container 20, from which the user of the dosing container 20 can read off the present volume of powder fertilizer components in the dosing container 20. This enables the user to determine the exact volume of fertilizer that has been dispensed.

To increase the internal pressure in the dosing container 20 and to break up solidifications of the powder fertilizer components, at least one of the container walls can be deformed. The two opposing dosing container walls can particularly preferably be moved towards each other, particularly by hand pressure, which brings about a defined increase in the internal pressure. The dosing container 20, in particular the dosing container walls, can be formed from a flexible material and when pressed together can generate a restoring force, which resiliently returns the dosing container wall towards its original alignment once the pressure is no longer acting on the dosing container wall.

The FIGURE shows in the upper part the dosing unit consisting of the receiving bowl 24, a container lid 32 and a dosing pipe 28. The container lid 32 can be stuck on the dosing container 20 by means of two parallel running stud links. In this case, the dosing pipe 28 projects vertically from the container lid for a more targeted discharge of the powder fertilizer components. Alternatively, the dosing pipe 28, particularly in the upper part, can also be arranged at an angle to the vertical axis and can have a plurality of pipe sections.

The dosing unit and the dosing container 20 can be manufactured from different materials in principle. Predominantly plastics, organic materials and metal are preferably used here. The dosing unit can differ from the rest of the dosing container 20 in terms of the material composition.

According to the FIGURE, the dosing pipe 28 transects the closed cover lid 30 and thereby connecting the outer region of the dosing container 20 to the receiving bowl 24. In this case, the receiving bowl 24 is held by the dosing pipe 28 in a horizontal position by means of two stud links 34, which are arranged in the side region of the dosing pipe 28 and connect the dosing pipe 28 to the receiving bowl 24. A screen 36 and a pivotable cover lid 30 for closing off the dosing pipe 28 can be designed at the outlet from the dosing pipe 28. Here, just as the container lid 32 is connected to the dosing container 20, the cover lid 30 can be releasably connected to the dosing pipe 28 by means of a push-in or twist closure.

1. A method for forming a plant nutrient solution, particularly for plants in house and garden, wherein
powder fertilizer components, particularly powder nutrient salts, are stored in a container, and
the powder fertilizer components are added to a carrier liquid, wherein the plant nutrient solution is formed for fertilizing,
wherein
a closed dosing container having a discharge opening at a top end of the dosing container is used as the container, wherein
a receiving bowl having a receiving opening directed towards the discharge opening of the dosing container and
a dosing pipe extending from the discharge opening up into the region of the receiving bowl
are arranged in the dosing container,
in that, in order to dispense a metered quantity of powder fertilizer components, the receiving bowl is filled with a quantity of powder fertilizer components, in particular by turning around the dosing container from the top side to the bottom side and back, and
in that, once the receiving bowl has been filled, the dosing container is turned from the top side to the bottom side, wherein a metered quantity of powder fertilizer components is discharged from the receiving bowl via the dosing pipe in a targeted manner through the downwardly directed discharge opening, in particular directly into the carrier liquid.

2. The method according to claim 1,
wherein
the receiving bowl is filled with a quantity of powder fertilizer components such that a lower end of the dosing pipe dips into the quantity of powder fertilizer components and a free passage of air from the dosing pipe into the dosing container is blocked.

3. The method according to claim 1,
wherein
the powder fertilizer components are screened during discharge.

4. The method according to claim 1,
wherein
an agent having hydrophilic properties is arranged in the dosing container, particularly in an upper region of the dosing container, separated from the fertilizer components, with which moisture is bound in the dosing container.

5. A dosing container for receiving powder fertilizer components, particularly powder nutrient salts, and for the targeted discharge of a metered quantity thereof, in particular to form a plant nutrient solution, particularly for plants in house and garden,
wherein
the container is designed as a closed dosing container having a discharge opening at a top end of the dosing container,
a receiving bowl having a receiving opening directed towards the discharge opening of the dosing container is designed in the dosing container for receiving a portion of fertilizer components, and
in that, moreover, a dosing pipe extending from the discharge opening up into the region of the receiving bowl is arranged in the dosing container,
the receiving bowl and the dosing pipe are arranged in relation to one another in such a way that by turning the dosing container from the top side to the bottom side and back, the receiving bowl can be filled with a quantity of powder fertilizer components, and
by turning around the dosing container from the top side to the bottom side, a metered quantity of powder fertilizer components can be discharged from the receiving bowl via the dosing pipe in a targeted manner through the downwardly directed discharge opening.

6. The dosing container according to claim 5,
wherein
a cover lid is arranged on the dosing pipe to close off the dosing pipe.

7. The dosing container according to claim 6,
wherein
the cover lid is mounted so as to be pivotable between a closed position and a discharge position, wherein the cover lid is in its closed position when the discharge opening is directed upwards, and the cover lid is in the discharge position when the discharge opening is directed downwards.

8. The dosing container according to claim 5,
wherein
the dosing pipe extends into a central region of the receiving bowl, wherein an annular through-gap for filling the receiving bowl is formed between the central dosing pipe and a surrounding wall of the receiving bowl.

9. The dosing container according to claim 5,
wherein
the dosing pipe is designed on a container lid which is deposit, particularly screwed, onto the discharge opening of the dosing container.

10. The dosing container according to claim 9,
wherein
the receiving bowl and the container lid with the dosing pipe are designed together as a dosing unit, in particular in one piece.

11. The dosing container according to claim 5,
wherein
the receiving bowl is joined to the dosing pipe by at least one stud link.

12. The dosing container according to claim 5,
wherein
the dosing pipe has a screen, through which the fertilizer components pass when the filled receiving bowl is turned and through which only particles of the fertilizer component up to a predefined size can pass.

13. The dosing container according to claim 5,
wherein
an agent having hydrophilic properties, particularly a silicate, is arranged in the dosing container.

14. The dosing container according to claim 5,
wherein
the dosing container narrows towards the top end, in particular in the region of the discharge opening.

15. The dosing container according to claim 5,
wherein
the container lid is connected to the dosing container by means of a push-in connection or a screw connection.
